(19) United States
(12) Patent Application Publication
(10) Pub. No.: US 2006/0280339 A1
(43) Pub. Date: Dec. 14, 2006

(54) System and method for performing user authentication based on keystroke dynamics

(76) Inventor: Sungzoon Cho, Seoul (KR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/448,029

(22) Filed: Jun. 6, 2006

Related U.S. Application Data
(60) Provisional application No. 60/689,253, filed on Jun. 10, 2005.

(30) Foreign Application Priority Data
Jul. 12, 2005 (KR) 10-2005-0062480

(51) Int. Cl. G06K 9/00

(52) U.S. Cl. 382/115

(57) ABSTRACT

There is provided a method and system for generating a timing vector for use in a user authentication system based on keystroke dynamics. The timing cues are presented to a user, who then types a password according to the timing cues. Then, a timing vector is generated based on the keystrokes of the typed password. The auditory and visual cues may include a repetitive sound played in a certain fixed tempo and a repetitive movement shown in a certain fixed tempo, respectively. The audiovisual cue may include simultaneous sound and movement rendered in a certain fixed tempo. Further, a list of exemplary artificial rhythms, which are used as keystroke dynamics when typing a password, may be presented to the user. The artificial rhythms and timing cues help a user to type a password having more unique and consistent patterns, which results in improved identity verification accuracy.

### CROSS REFERENCE TO RELATED APPLICATIONS

This application is based upon and claims the benefit of U.S. Provisional Application No. 60/689,253, filed Jun. 10, 2005 and priority from Korean Patent Applications No. 2005-62480, filed on Jul. 12, 2005; the entire contents of which are incorporated herein by reference.

### FIELD OF THE INVENTION

The present invention generally relates to a system and method for performing user authentication based on keystroke dynamics, and more particularly to a system and method for generating unique and consistent keystroke patterns for use in performing user authentication based on keystroke dynamics by providing timing cues at user enrollment and authentication stages.

### BACKGROUND OF THE INVENTION

Biometrics is now widely used for performing accurate user authentications. Biometrics refers to a method of identifying a person based on his/her physiological or behavioral characteristics. Such method of identification is preferable over the conventional methods, which typically involve passwords and PIN numbers, for the following reasons: (i) the person to be identified must be physically present at the point of identification; and (ii) the identification using the biometric techniques does not require any password or object (e.g., key). The biometric techniques can prevent unauthorized or fraudulent use of ATM cards, cellular phones, smart cards, desktop PCs, workstations, computer networks, etc.

As discussed above, biometrics can be performed based on a user's physiological characteristics such as fingerprints, facial features, irises, palm prints, etc. Such physiological characteristics are unique to an individual and are consistently preserved over time, thereby serving as highly reliable and accurate forms of identification. However, the biometrics based on physiological characteristics does not depend on the user's behavior, but rather heavily depends upon the input device involved. Thus, in order to improve the accuracy of identification, the overall costs of the biometrics system must inevitably increase.

Due to various advantages such as low cost, user-friendliness and facilitated remote access control, behavioral biometrics such as keystroke dynamics is gaining popularity in the field of user authentication. The keystroke dynamics refer to a method of how a user types a password at an input device (e.g., keyboard) of a user authentication system. Specifically, the keyboard dynamics measure two distinct variables, namely, the “dwell time” (amount of time a user holds down a particular key) and the “flight time” (amount of time it takes a user to type between keys).

One type of conventional use authentication system, which is based on the keystroke dynamics, is disclosed in U.S. Pat. No. 4,805,222 (issued on Feb. 14, 1989 to James R. Young, et al.). In such use authentication system, the following three steps are performed: registering or enrolling a user's key strokes (i.e., timing vector patterns); building a classifier using the timing vector patterns; and when a new timing vector pattern is presented, accepting or rejecting the user's identification based on the classification made by the classifier. However, the identification accuracy is relatively low in this system since the behavioral biometrics such as keystroke dynamics is not typically consistent.

In the recent years, many user authentication systems are increasingly accurate since they adopted rather complex models such as a neural network, support vector machine and genetic algorithm. Thus, a user authentication system, which employs a neural network and recognizes a user's timing vector patterns, is highly desirable for identification purposes since such a system is subject to less error compared to the conventional user identification systems. However, when only a small number of timing vector patterns is available, such a system can be subject to an increasing number of errors.

### SUMMARY OF THE INVENTION

It is, therefore, an object of the present invention to provide a system and method for generating unique and consistent keystroke patterns so as to better distinguish between user's keystroke patterns and imposter's keystroke patterns in a user authentication system based on keystroke dynamics.

According to one aspect of the present invention, there is provided a method of generating a timing vector for use in a user authentication system, which is based on keystroke dynamics. Such a method includes the following steps: presenting timing cues to a user; receiving keystrokes typed by the user according to the timing cues; and generating a timing vector based on the received keystrokes.

Preferably, the timing cues include at least one auditory cue, a visual cue and/or an audiovisual cue. The auditory and visual cues may include a repetitive sound played in a certain fixed tempo and a repetitive movement shown in a certain fixed tempo. Further, the audiovisual cue may include simultaneous sound and movement rendered in a certain fixed tempo.

The method of the present invention may further include the step of presenting a list of exemplary artificial rhythms to a user. The artificial rhythms may include at least one pause, musical rhythm, staccato, legato and/or slow tempo.

According to another aspect of the present invention, there is provided a user authentication system, comprising: a timing cue generation module for generating and presenting timing cues to a user; and a timing vector generation module for receiving keystrokes typed by the user according to the timing cues and generating a timing vector based on the received keystrokes.

It is preferable that the timing cues include at least one auditory cue, a visual cue and/or an audiovisual cue. The auditory and visual cues may include a repetitive sound played in a certain fixed tempo and a repetitive movement shown in a certain fixed tempo. Further, the audiovisual cues may include simultaneous sound and movement rendered in a certain fixed tempo.

The user authentication system may further include an artificial rhythm generation module for presenting a list of exemplary artificial rhythms to a user. The artificial rhythms may include at least one pause, musical rhythm, staccato, legato and/or slow tempo. The system may further include: a timing vector database for storing the generated timing vector; a classifier building module for building a timing vector classifier based on the timing vector stored in the timing vector database; and a timing vector classifier for performing user verification based on the generated timing vector.

### BRIEF DESCRIPTION OF THE DRAWINGS

The above and other objects and features in accordance with the present invention will become apparent from the following descriptions of preferred embodiments in conjunction with the accompanying drawings, in which:

FIG. 1 shows the uniqueness, inconsistency and discriminability values of timing vector patterns based on implementing keystrokes for a set of passwords;

FIGS. 2A to 2H show graphs of timing vector patterns generated in experiments, wherein a user types one password according to natural and artificial rhythms in accordance with one embodiment of the present invention;

FIG. 3 shows the uniqueness, inconsistency and discriminability values of timing vector patterns obtained by using the artificial rhythms in accordance with one embodiment of the present invention;

FIGS. 4A to 4H show the cumulative distributions of distances from training timing vectors (Tr20), test timing vectors (Test) and imposter's timing vectors (Imposter) when employing the artificial rhythms in accordance with one embodiment of the present invention;

FIG. 5 shows a flowchart for a method of generating timing vectors, which are used in a user authentication system based on keystroke dynamics, in accordance with one embodiment of the present invention;

FIGS. 6A and 6B show the cumulative distributions of distances from training timing vectors (Tr20), test timing vectors (Test) and imposter's timing vectors (Imposter) when typing a password according to the artificial rhythms of Slow Tempo and Slow Tempo with an auditory cue in accordance with one embodiment of the present invention;

FIG. 7 shows a video clip of a hammer hitting a nail on a wooden block, which is presented to the users as visual cues in accordance with one embodiment of the present invention;

FIG. 8 shows the average uniqueness, inconsistency and discriminability values of timing vectors obtained from five different users subject to various cues in accordance with one embodiment of the present invention;

FIG. 9 shows a user authentication system, which is based on keystroke dynamics, in accordance with one embodiment of the present invention;

FIG. 10 shows a user authentication system based on keystroke dynamics in accordance with one embodiment of the present invention, wherein the elements of the system are distributed over a communication network; and

FIG. 11 shows a flowchart for a method of performing user authentication based on keystroke dynamics in accordance with one embodiment of the present invention.

### DETAILED DESCRIPTION OF THE PRESENT INVENTION

The present invention is directed to a system and method for generating unique and consistent timing keystroke patterns so as to better distinguish between user's keystroke patterns and imposter's keystroke patterns in a user authentication system based on keystroke dynamics. The quality of keystroke dynamics can be defined by two factors, namely, uniqueness and consistency. Uniqueness refers to how different the imposter's keystroke patterns are compared to those enrolled in an enrollment stage. Uniqueness depends on the user's typing style. On the other hand, consistency refers to how similar the user's keystroke patterns are compared to those enrolled in the enrollment stage. Consistency depends on the user's typing skill and concentration level. A combination of high consistency and high uniqueness tends to lead to a better discrimination or classification between the user's keystroke patterns and the imposter's keystroke patterns.

The present invention provides the measures for uniqueness, consistency and discrimination of keystroke patterns (or timing vectors generated based on the keystroke patterns) for use in a user authentication system. As discussed above, the uniqueness of keystroke patterns refers to how different the user's keystroke patterns are compared to those of the imposter. Therefore, a measure of uniqueness can be defined as the average distance of imposter's keystroke patterns from the prototype or centroid of user's keystroke patterns registered in the enrollment stage.

$$\{ \vec{{x}_{i}} \vert i = 1 , … , {N}_{x} \} , \{ \vec{{y}_{j}} \vert j = 1 , … , {N}_{y} \} and \{ \vec{{z}_{k}} \vert k = 1 , … , {N}_{z} \}$$

denote a set of valid user's training (enrollment) keystroke patterns, a set of valid user's test keystroke patterns and a set of imposter's keystroke patterns, respectively. If given a prototype keystroke pattern

$$\vec{m} = {\sum }_{i} \vec{{x}_{i}} / {N}_{x} ,$$

then the uniqueness can be defined as:

$$Uniqueness = {\sum }_{k = 1}^{{N}_{z}} \vert \vec{{z}_{k}} - \vec{m} \vert / {N}_{z} - {\sum }_{i = 1}^{{N}_{x}} \vert \vec{{x}_{i}} - \vec{m} \vert / {N}_{x} \qquad ( 1 )$$

Further, as discussed above, consistency refers to how similar the user's future keystroke patterns will be compared to his/her current keystroke patterns. Accordingly, a measure of inconsistency, which is the opposite concept of consistency, can be defined as the average distance of user's own future keystroke patterns to the prototype or centroid of user's keystroke patterns registered in the enrollment stage, as shown below:

$$Inconsistency = {\sum }_{j = 1}^{{N}_{y}} \vert \vec{{y}_{j}} - \vec{m} \vert / {N}_{y} - {\sum }_{i = 1}^{{N}_{x}} \vert \vec{{x}_{i}} - \vec{m} \vert / {N}_{x} \qquad ( 2 )$$

A measure of so-called discrimination or discriminability can be defined as the difference between the smallest distance from the imposter's keystroke patterns to the prototype and the largest distance from the user's future keystroke patterns to the prototype, as shown below:

$$Discriminability = {min}_{k} \vert \vec{{z}_{k}} - \vec{m} \vert - {max}_{j} \vert \vec{{y}_{j}} - \vec{m} \vert \qquad ( 3 )$$

In Equation (3), when the former (minimum distance from the imposter's keystroke patterns to the prototype) is smaller than the latter (maximum distance from the user's future keystroke patterns to the prototype), a negative discriminability value is obtained. If the imposter's keystroke patterns are closer to the prototype than the user's own keystroke patterns, then a user authentication system cannot achieve a perfect discrimination. Particularly, a negative discriminability value implies that a simple classification based on Euclidean distance metric may not achieve a perfect discrimination, whereas employing other metrics may obtain a better or even perfect discrimination. On the other hand, when the former is larger than the latter in Equation (3), a positive discriminability value is obtained. If every one of the imposter's keystroke patterns are farther from the prototype than the user's future keystroke patterns (i.e., there is no overlap between the two distance distributions), then a user authentication system can achieve a perfect discrimination with the use of a proper threshold. In such a case, the larger the difference between the two distance distributions, the better discrimination the user authentication system obtains since it is easier to find a threshold corresponding to a perfect discrimination.

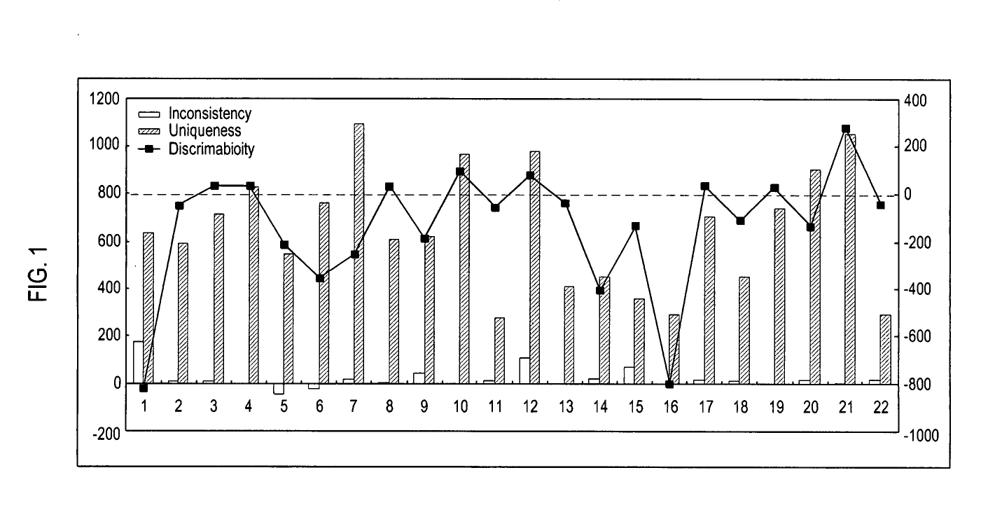

The inventor carried out an experiment to show how the uniqueness and consistency of keystroke dynamics are related to the discriminability. FIG. 1 shows the uniqueness, inconsistency and discriminability values, which were calculated by using the measures as defined in Equations (1) to (3) for 22 passwords. The keystroke pattern set for each password comprises hundreds of user's keystroke patterns for training, 75 user's keystroke patterns for testing, and 75 imposter's keystroke patterns for testing. The keystroke pattern sets (except the one for the password number 22) are disclosed in U.S. Pat. No. 6,151,593 and Yu, E. and Cho., S., “Keystroke Dynamics Identity Verification—Its Problem and Practical Solutions,” Computers and Security, 23(5), pp. 428-440, 2004. Inconsistency ranges mostly from −20 to 60 (with two exceptions in connection with the keystroke pattern sets for the password numbers 1 and 12), whereas uniqueness ranges from 300 to 1100. As shown in FIG. 1, it is understood that discriminability has a positive correlation coefficient with uniqueness (0.36) and a negative correlation coefficient with inconsistency (−0.33). Thus, discriminability can be improved by increasing the uniqueness or by decreasing the inconsistency.

The present invention provides methods of increasing the uniqueness and consistency of keystroke dynamics in order to improve discriminability in a user authentication system. In one embodiment of the present invention, artificial rhythms are used to increase the uniqueness of keystroke dynamics. The artificial rhythms may include at least one pause, musical rhythm, staccato, legato and/or slow tempo.

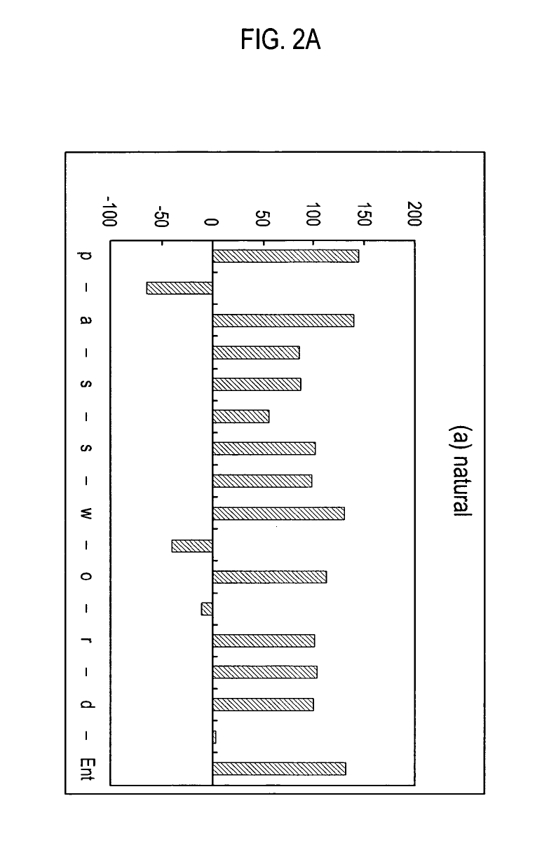

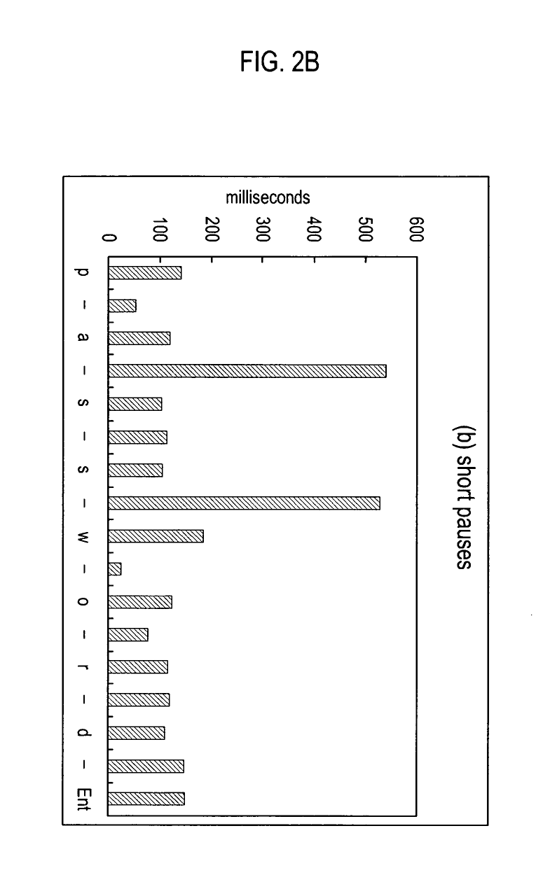

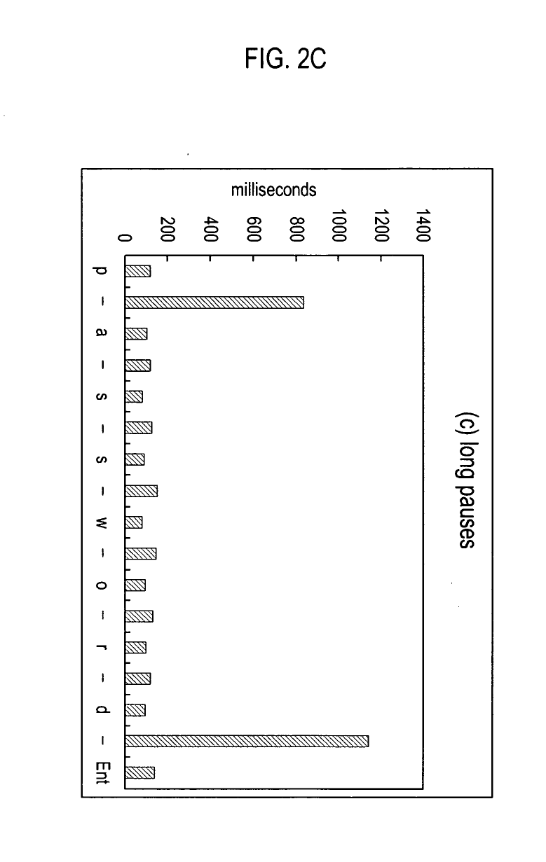

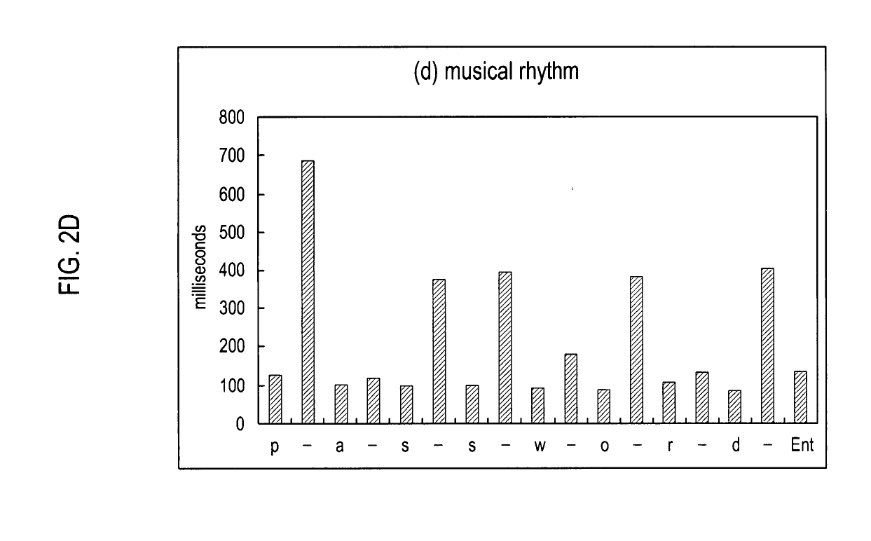

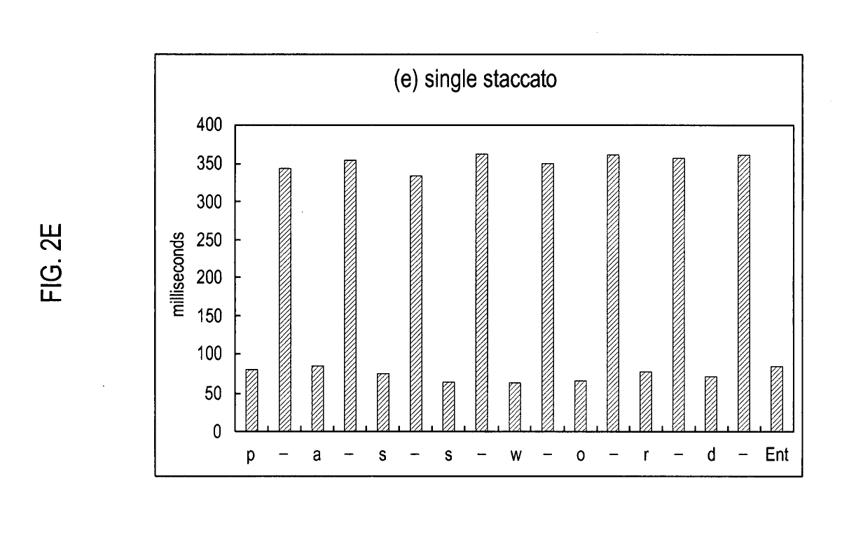

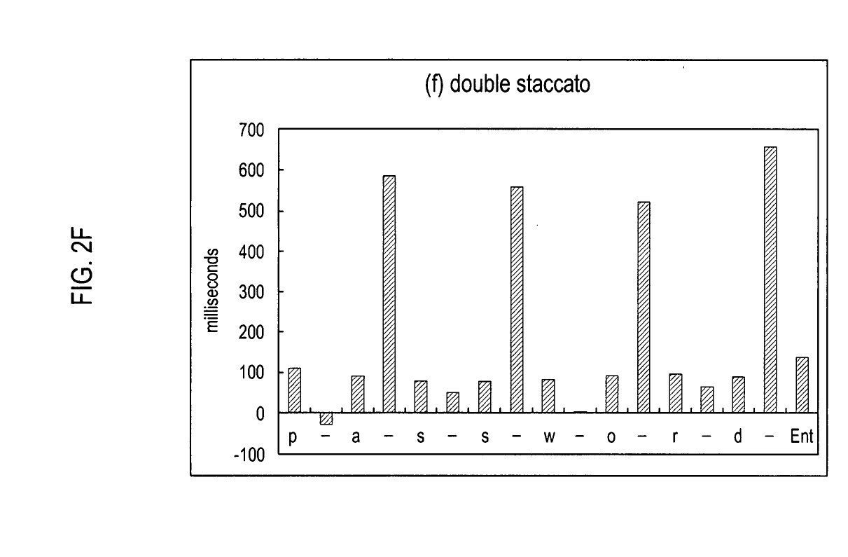

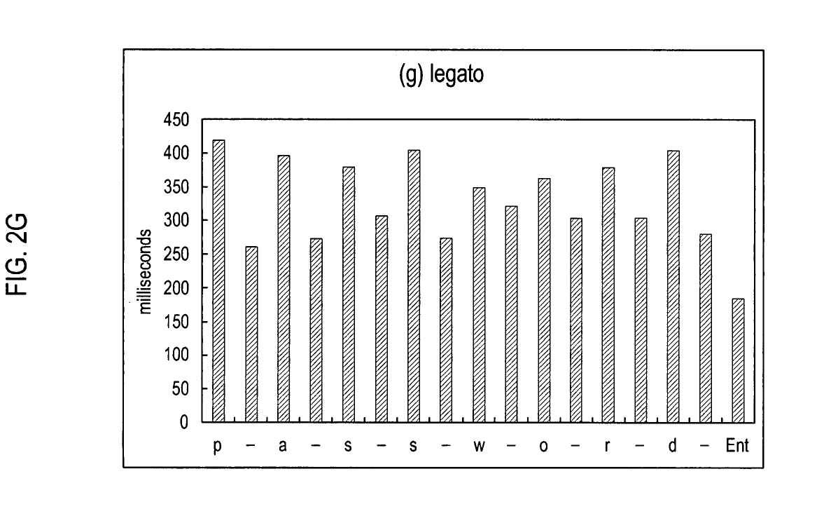

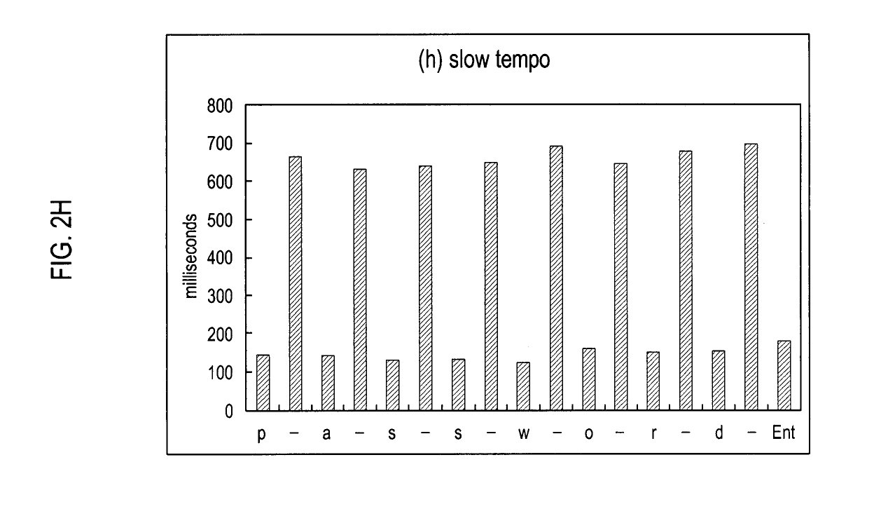

The inventor conducted several experiments, wherein one user types one password (“password”) according to the artificial rhythms, to check how typing according to the artificial rhythms increases the uniqueness of keystroke dynamics. In one experiment, the user typed the password in a natural rhythm (hereinafter referred to as the “Natural Rhythm”) for 20 times. As a result, the length of an interval occurring in a natural rhythm ranges from 50 to 200 msec, as shown in FIG. 2A. Then, each of the artificial rhythms was employed for typing the password, as follows.

First, a number of pauses were inserted between the characters when typing the password, as shown in FIGS. 2B and 2C. In one experiment as shown in FIG. 2B, an artificial rhythm containing two short pauses (hereinafter referred to as the short “Pauses”) was attempted to type the password (“pa_ss_word”). That is, the user types ‘p’ and ‘a’ in a natural rhythm, and then inserts a pause that is two beats long. Thereafter, typing ‘s’ twice in a natural rhythm is followed by another pause that is two beats long. Finally, ‘w’, ‘o’, ‘r’and ‘d’ are typed in a natural rhythm. In another experiment as shown in FIG. 2C, an artificial rhythm comprising two long pauses (hereinafter referred to as the long “Pauses”) was attempted to type the password (“p_assword_”), which contains two long pauses that are three beats and four beats long. In order to count the beats accurately, the user may use his right thumb to hit a keyboard area, which is located below the space bar. The user can arbitrarily determine the number and length of pauses to be used in typing a password. In such a case, the longer pauses will make the user's keystroke patterns more unique.

Second, typing a password according to a musical rhythm increases the uniqueness of keystroke dynamics. In one experiment, an artificial rhythm according to a particular rooting rhythm (which was used and popularized by Korean soccer fans during the World Cup 2002 Korea-Japan; hereinafter referred to as the “Musical Rhythm”) was attempted to type the password, as shown in FIG. 2D. The Musical Rhythm is advantageous since it is easy for the user to remember and thus results in more consistent keystroke patterns.

Third, a user may type his/her password with a minimum duration of time for each character included in the password. That is, an artificial rhythm (hereinafter referred to as the “Staccato”) can be adopted from a bowing style for string instruments characterized by “being cut short crisply and detached.” In two experiments, two types of Staccato were tried when typing the password, that is, single character staccato and double (two consecutive) character staccato, as shown in FIGS. 2E and 2F. The double staccato patterns were collected with ‘p’ and ‘a’, which were typed together as quickly as possible, followed by a pair of ‘s’ and ‘s’ typed together as rapidly as possible. A pair of ‘w’ and ‘o’ as well as a pair of ‘r’ and ‘d’ were typed in the same manner. Typing a password according to the Staccato results in keystroke patterns, which are very short in duration and very uniform in interval lengths. A typical duration, which occurs in a natural rhythm, ranges from 100 to 130 msec, whereas the duration obtained from typing according to the Staccato ranges from 50 to 80 msec, as shown FIG. 2E.

Fourth, in one experiment, legato style typing (hereinafter referred to as the “Legato”), which is the opposite to the staccato, was attempted to keep each character key down as long as possible (i.e., to maximize the duration time of each character included in the password). Keystroke patterns obtained by the Legato tend to have longer duration ranging from 350-400 msec, as shown in FIG. 2G Both the Staccato and Legato style typing produce fairly consistent typing patterns. However, one disadvantage is that there is less room for variation compared to the Pauses.

Fifth, in one experiment, the password was typed in a slow tempo (hereinafter referred to as the “Slow Tempo”). FIG. 2H shows a prototype keystroke pattern with prolonged intervals, each of which is 600 to 700 msec long. A user may slow down his/her typing of a password as much as he/she desires. However, it is difficult to maintain consistent typing patterns when the tempo becomes too slow.

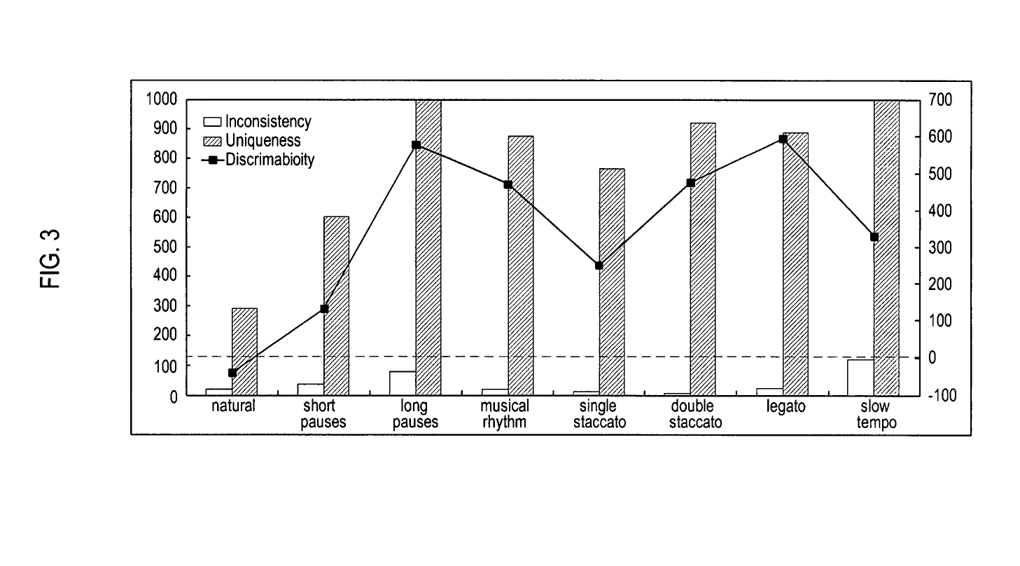

FIG. 3 shows the uniqueness (solid line), inconsistency (left scale) and discriminability (right scale) values of a set of keystroke patterns obtained using the above-described artificial rhythms, wherein the uniqueness values (1300 and 1540) of keystroke patterns generated according to the long Pauses and Slow Tempo are reduced to fit to 1000. As shown in FIG. 3, the uniqueness values of keystroke patterns were increased from at least 200% (short Pauses) to 500% (Slow Tempo), whereas the inconsistency values thereof did not increase much with the exceptions of long Pauses and Slow Tempo. Furthermore, the discriminability values of all six artificial rhythms are positive. Therefore, all the keystroke patterns generated according to the artificial rhythms can be perfectly discriminated with a proper threshold.

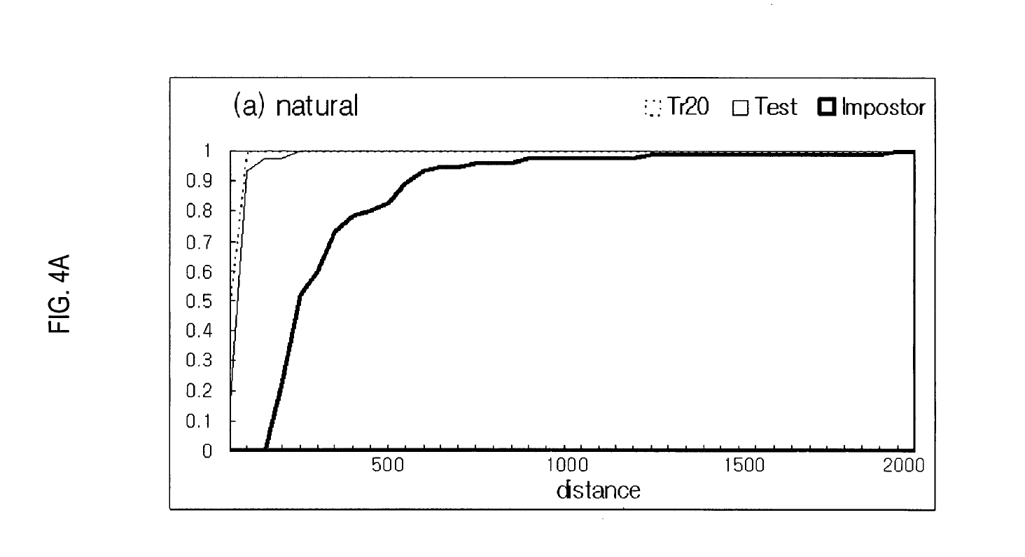

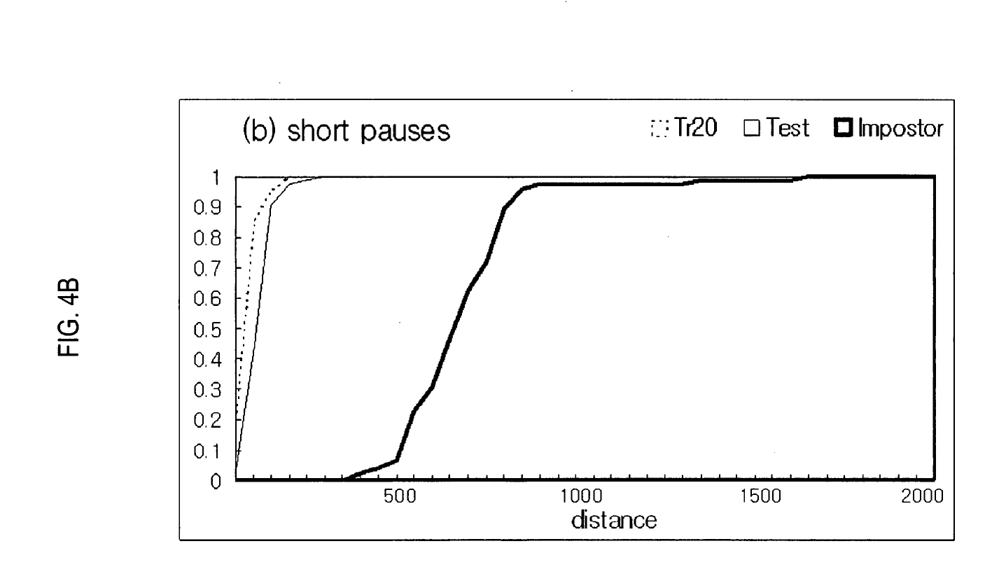

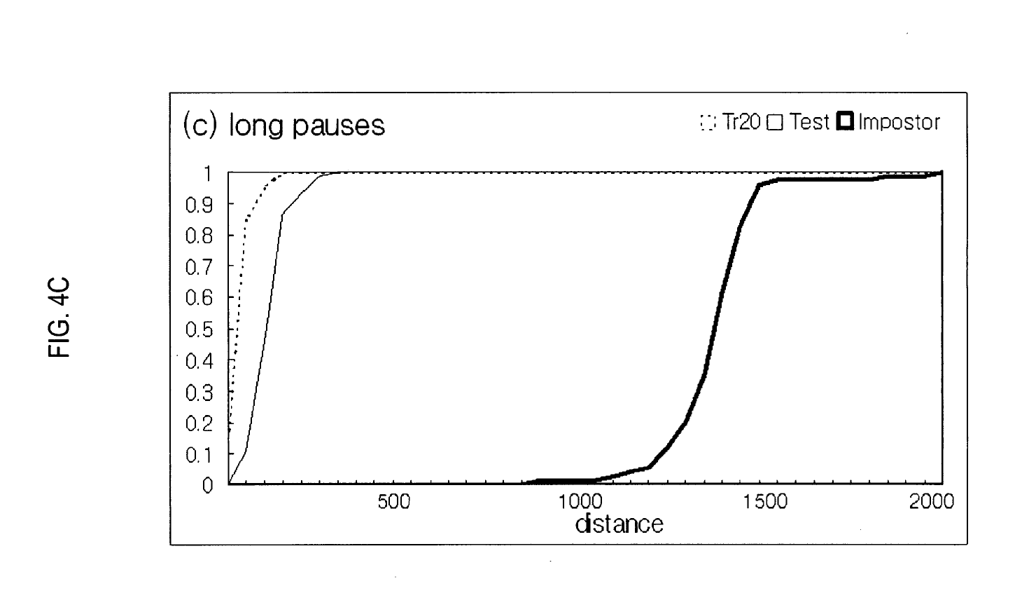

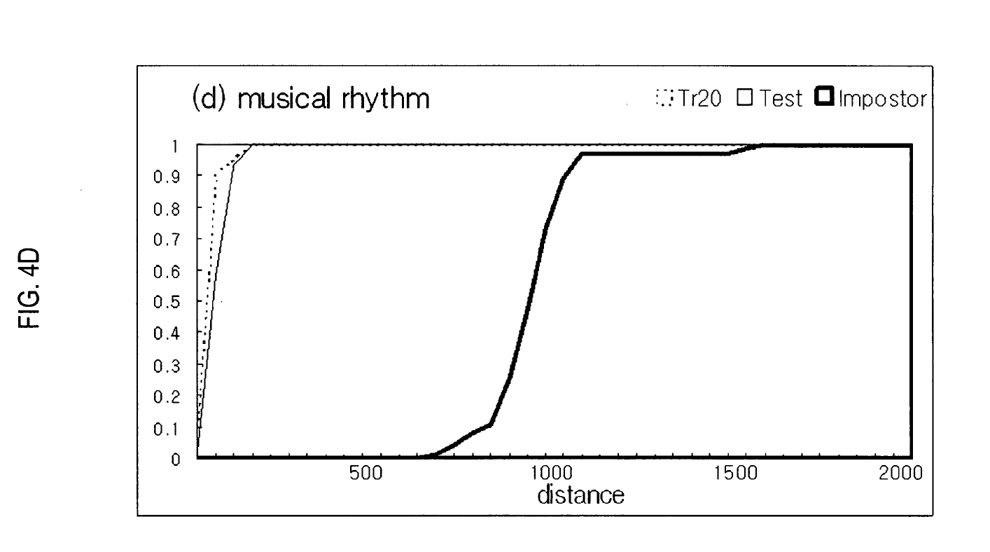

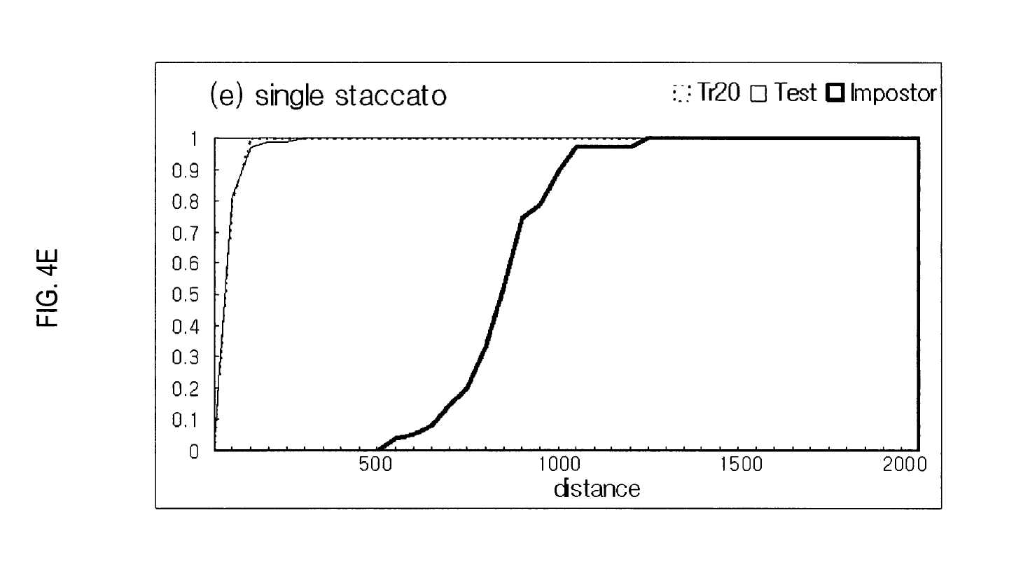

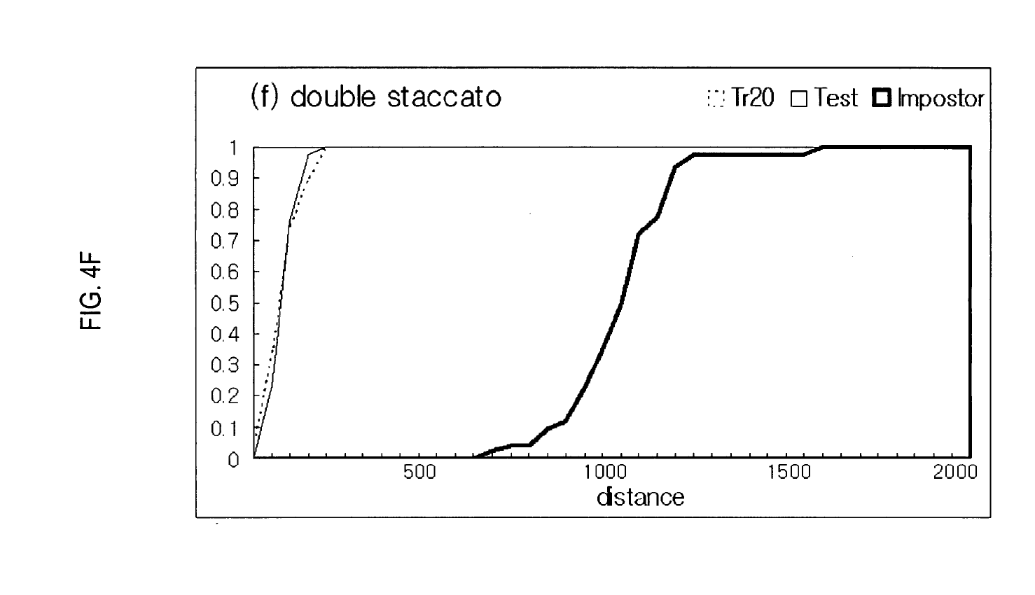

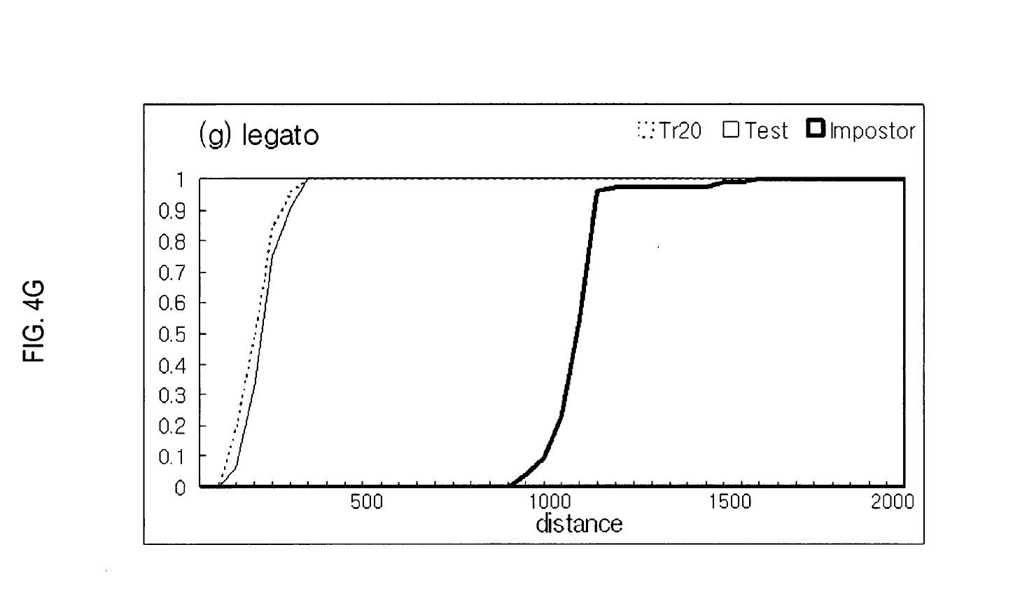

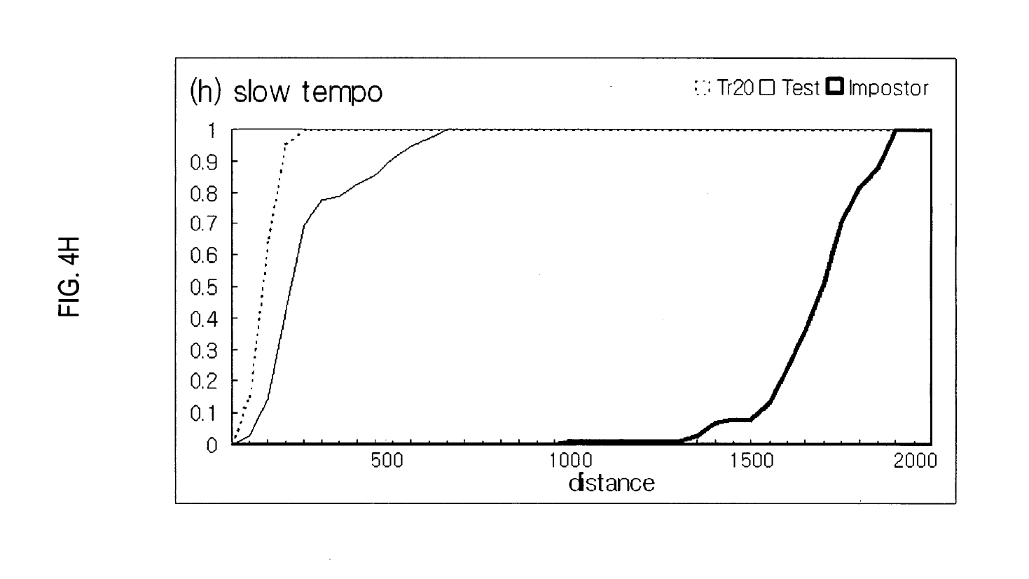

FIGS. 4A to 4H show the cumulative distributions of distances from training keystroke patterns (“Tr20”; indicated as dotted curve), test keystroke patterns (“Test”; indicated as solid curve) and imposter's keystroke patterns (“Imposter”; indicated as thick solid curve) when employing the artificial rhythms: the Natural Rhythm, short Pauses, long Pauses, Musical Rhythm, single Staccato, double Staccato, Legato and Slow Tempo, respectively. As shown by the measure in Equation (3), discriminability is related to the distance between the solid curve in the middle (Test) and the thick solid curve to the right (Imposter) in FIGS. 4A to 4H. That is, the farther the distance becomes, the better the discriminability can be obtained. When the curves of FIG. 4A (Natural Rhythm) are compared to those of the other figures (artificial rhythms), it is understood that the Imposter curve shifts to the right and away from the Test curve. Such separation of test keystroke patterns and imposter's keystroke patterns allows for perfect discrimination. However, as shown in FIGS. 4C and 4H, employment of the long Pauses and Slow Tempo pushed the Test curves to right, which was caused by a decrease of consistency in typing. Such a decrease of consistency in typing can be remedied by using proper timing cues.

Table 1 summarizes the above-described advantages and disadvantages of employing the artificial rhythms in accordance with the present invention, together with the methods of improving the typing consistency.

TABLE 1
Artificial Rhythms for increasing the Typing Uniqueness

| | Advantages | Disadvantages | Remedies |
|---|---|---|---|
| Pauses | Flexible | Inconsistent when long | Use of timing cues |
| Musical | Consistent, | Rhythmical sense is | |
| Rhythms | Easy to | required | |
| | remember | | |
| Staccato | Consistent | Limited | |
| Legato | Consistent | Limited, Exact duration | Use of timing cues |
| Slow | Flexible | Inconsistent | Use of timing cues |
| Tempo | | | |

In the following sections, preferred embodiments in accordance with the above-described principles of the present invention will be described in detail with reference to the drawings.

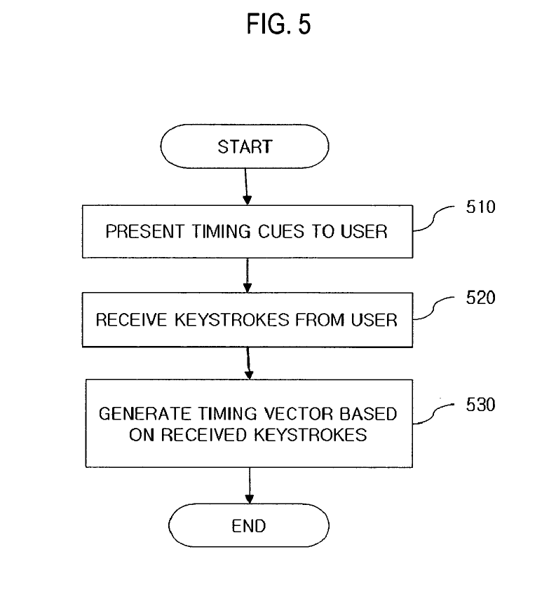

FIG. 5 illustrates a flowchart for a method of generating timing vectors for use in a user authentication system based on keystroke dynamics in accordance with one embodiment of the present invention. The timing vectors generated in accordance with the method as shown in FIG. 5 may be used for both the user enrollment stage and user authentication stage in a user authentication system.

As shown in FIG. 5, the timing cues are presented to a user (operation 510). The timing cues help the user to type a password with more consistent keystroke pattern at both the user enrollment stage and user authentication stage. Particularly, it is preferable that the timing cues are presented to a user who types the password according to the artificial rhythms. Further, although not shown in FIG. 5, a number of exemplary artificial rhythms may be presented to the user before or at the time of presenting the timing cues. This is so that the user can select one of the artificial rhythms to be used in typing the password.

The timing cues may include at least one auditory cue, a visual cue and/or an audiovisual cue. The auditory cue includes any type of repetitive sound played in a certain fixed tempo. For example, a mechanical sound such as one produced by a metronome, musical notes and human/animal voices and sounds may serve as the auditory cue. The visual cue includes any type of repetitive movement shown in a certain fixed tempo. For example, human/animal motion and object motion such as counter, discretely growing bar, blinking image, pounding hammer, rotating clock and flipping coin may serve as the visual cue. The audiovisual cue includes simultaneous sound and movement rendered in a certain fixed tempo.

Thereafter, the user authentication system receives keystrokes from the user typing a password by means of the timing cues (operation 520). Based on the keystrokes received from the user, the user authentication system generates a timing vector (operation 530). The timing vector generated based on the received keystrokes may include information based on a series of alphanumeric characters, durations of the characters (“dwell time”) and intervals between the characters (“flight time”).

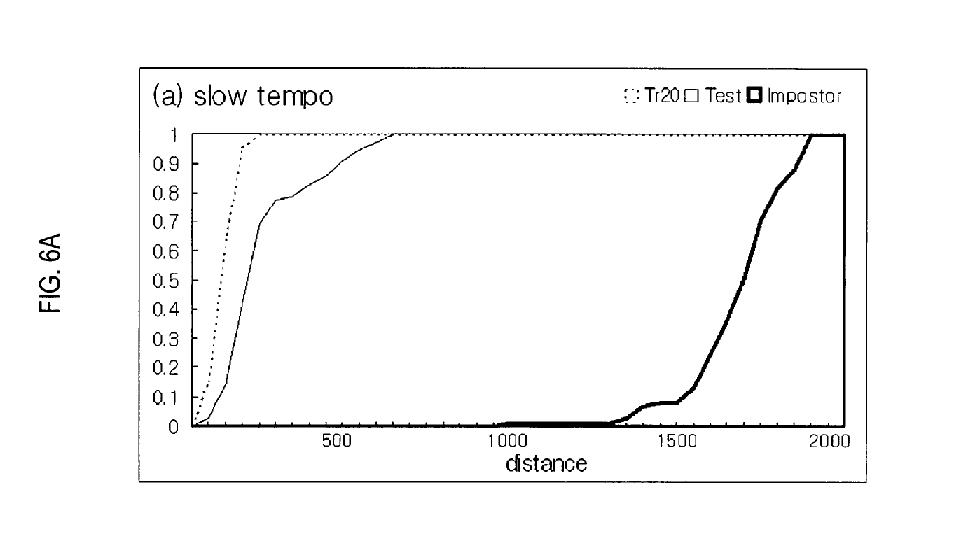

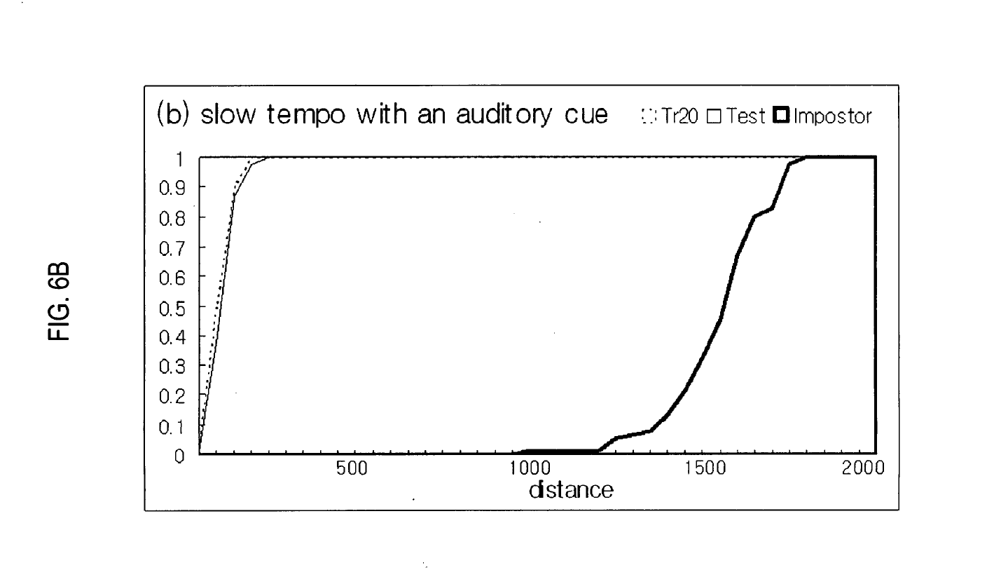

The inventor conducted several experiments to determine if the timing cues improve the consistency of keystrokes dynamics. The keystroke patterns according to the Slow Tempo, which have a high inconsistency value in FIG. 3, were collected again while presenting an auditory cue ticking every 750 msec to a user. The results of the experiments showed that the inconsistency value was reduced from 121 to 8, whereas the uniqueness value was slightly reduced to 1436 from 1540. Thus, the discriminability value was increased from 330 to 728. In short, consistency was improved by almost 15 fold whereas discriminability was improved by more than two fold with a simple auditory cue. FIGS. 6A and 6B show the cumulative distributions of distances from the training keystroke patterns (“Tr20”; indicated as dotted line), test keystroke patterns (“Test”; indicated as solid line) and imposter's keystroke patterns (“Imposter”; indicated as thick solid line) when the password was typed according to the Slow Tempo (FIG. 6A) and Slow Tempo with an auditory cue (FIG. 6B). As shown in FIGS. 6A and 6B, it is understood that the user's typing patterns became quite similar by means of an auditory cue.

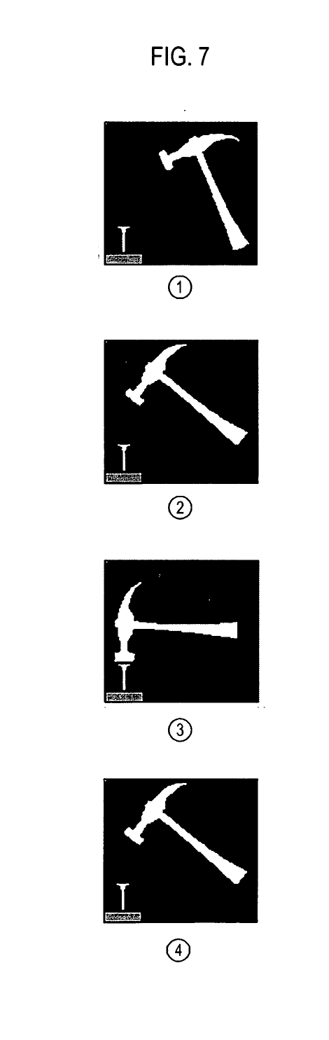

Further, the effectiveness of various timing cues with long Pauses (“pass_word_”), which contain two long pauses that are each four beats long, was tested in one experiment. In this experiment, five different users typed a password according to the long Pauses by means of three timing cues, namely, auditory, visual and audiovisual cues. First, the sound of ticking at a speed of 160 per minute from a metronome was used for the auditory cue. Second, a video clip showing a hammer hitting a nail on a wooden block at a speed of 160 per minute, which comprises 4 image frames as shown in FIG. 7, was presented to the users. Third, a synchronized combination of both the auditory cue and visual cue was also presented to the users as the audiovisual cue.

TABLE 2
Inconsistency, Uniqueness and Discriminability of
Keystroke Patterns obtained with various timing
cues in accordance with the present invention.

| | | Incon- | Unique- | |
|---|---|---|---|---|
| User ID | Timing Cue | sistency | ness | Discriminability |
| User No. 1 | No cue | 786 | 2127 | 227 |
| | Visual cue | 111 | 3674 | 2520 |
| | Auditory cue | 84 | 2361 | 1705 |
| | Audiovisual cue | 12 | 2245 | 1591 |
| User No. 2 | No cue | −4 | 2281 | 1695 |
| | Visual cue | −32 | 2235 | 1553 |
| | Auditory cue | 28 | 2339 | 1554 |
| | Audiovisual cue | 25 | 2310 | 1555 |
| User No. 3 | No cue | 59 | 766 | 172 |
| | Visual cue | 21 | 1190 | 667 |
| | Auditory cue | 45 | 888 | 251 |
| | Audiovisual cue | 35 | 1072 | 579 |
| User No. 4 | No cue | 69 | 720 | −161 |
| | Visual cue | 59 | 1193 | 503 |
| | Auditory cue | 27 | 1329 | 579 |
| | Audiovisual cue | 17 | 1276 | 559 |
| User No. 5 | No cue | 82 | 1746 | 918 |
| | Visual cue | 32 | 2140 | 1401 |
| | Auditory cue | 24 | 2211 | 1594 |
| | Audiovisual cue | 18 | 2227 | 1628 |

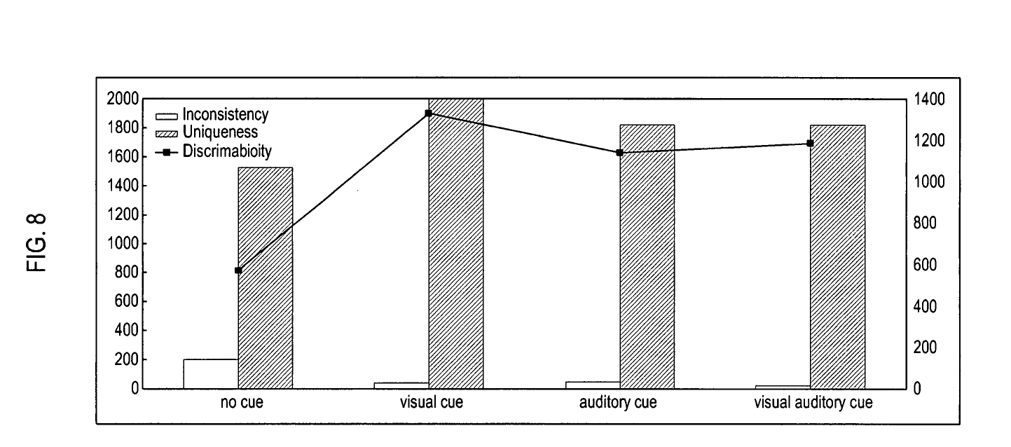

Table 2 shows how the timing cues affect inconsistency, uniqueness and discriminability of the keystroke patterns. As shown in Table 2, as to the User No. 1, inconsistency decreased to 10 to 70 times without affecting uniqueness. As a result, discriminability increased significantly from 7 to 12 times. As for the User No. 2, the use of visual cue helps to reduce inconsistency. As for the User Nos. 3 to 5, all three timing cues helped the users to type a password in a more consistent way. These results show that it is up to the user to determine which timing cue is the most effective in producing consistent keystroke patterns. FIG. 8 shows the average uniqueness, inconsistency and discriminability values of the keystroke patterns of the five users, wherein the uniqueness of the keystroke patterns generated by means of visual cue is 2,086 but was reduced to 2,000 for a display purpose. As shown in FIG. 8, it is understood that the use of the timing cues decreased inconsistency and increased discriminability of the keystroke patterns.

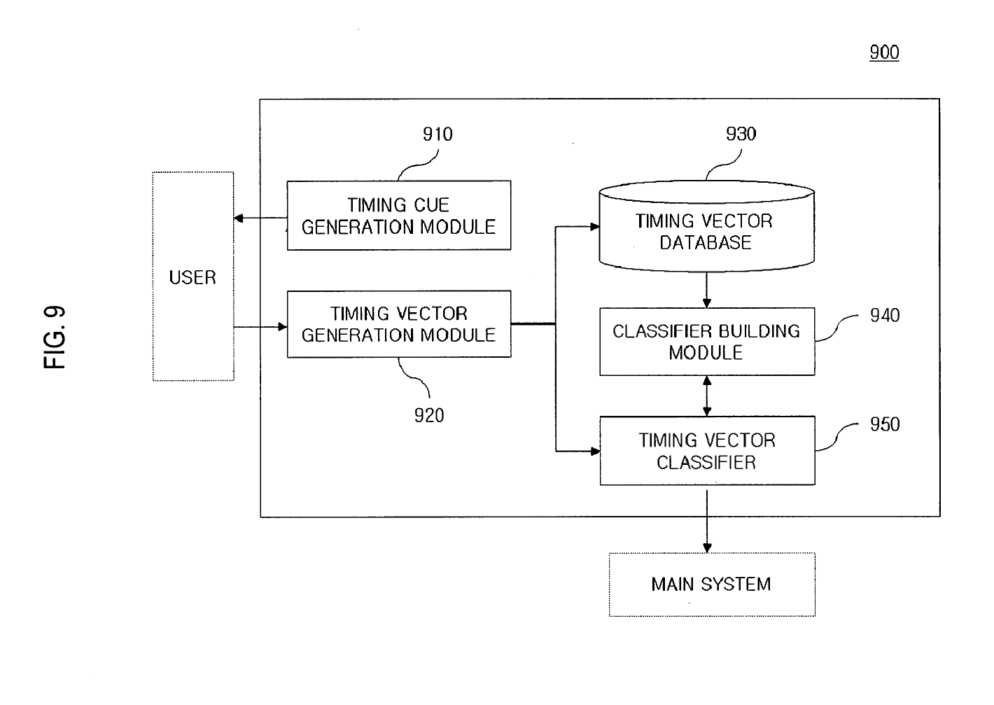

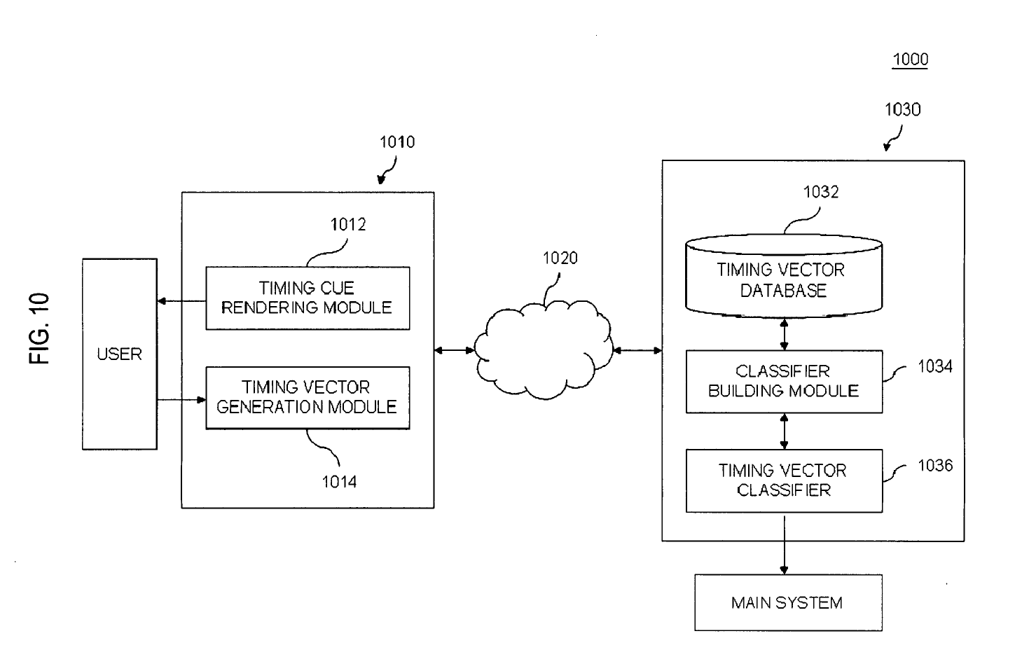

In the following discussion, the preferred embodiments of a user authentication system based on keystroke dynamics in accordance with the present invention will be described in detail with reference to FIGS. 9 and 10.

FIG. 9 depicts a user authentication system based on keystroke dynamics in accordance with one embodiment of the present invention. In this embodiment, the user authentication system 900 may be included in or connected to any type of computing device such as ATM, cellular phone, smart card, laptop computer, desktop computer, workstation, etc. The user authentication system 900 includes a timing cue generation module 910 and a timing vector generation module 920. The timing cue generation module 910 generates and presents timing cues to a user. The user then uses the timing cues to type a password through an input device (e.g., keypad, keyboard, etc. (not illustrated)). As mentioned above, the timing cues include at least one auditory cue, a visual cue and/or an audiovisual cue. The timing cue generation module 910 may be implemented by using any type of output device such as loud speakers, LEDs and LCD display panels. Further, although not shown in FIG. 9, a number of exemplary artificial rhythms may be presented to the user through an output device before or when the timing cue generation module 910 presents the timing cues to the user. This is so that the user can select one of the artificial rhythms, which are to be used in typing a password.

The timing vector generation module 920 receives keystrokes from a user through the input device and generates a timing vector based on the received keystrokes. The timing vector generated based on the received keystrokes may include information based upon a series of alphanumeric characters, durations of the characters and intervals between the characters.

In a user enrollment stage, the timing vector generated by the timing vector generation module 920 is forwarded to and stored in the timing vector database 930. The timing vector database 930 may store a list of users and numerous sets of timing vectors corresponding to the respective users. The timing vectors stored in the timing vector database 930 are used by a classifier building module 940 in building (or training) a timing vector classifier 950. Generally, it is preferable that a large number of training timing vectors are available for building the timing vector classifier 950 in order to secure practically acceptable classification error rates. However, since the timing cues are provided by the timing cue generation module 910 to assist the user in typing a password with more consistent keystroke patterns, only a small number of training timing vectors are sufficient for building the timing vector classifier 950, which has an acceptable error rate.

Further, if the timing vector classifier 950 employs a simple pattern matching algorithm such as Euclidean distance metric, then the classifier building module 940 can be omitted from the user authentication system 900. In such a case, the timing vector stored in the timing vector data 930 is used as a template (or reference) timing vector, which is compared to a user's test timing vector by the timing vector classifier 950 in the user authentication stage.

In the user authentication stage, the timing vector classifier 950 receives a timing vector generated by the timing vector generation module 920 and performs a user verification procedure based on the received timing vector and/or the timing vector registered in the user enrollment stage. That is, the timing vector classifier 950 may determine if the difference between the received timing vector and the enrolled timing vector falls within a predetermined threshold. Then, the user verification result is transmitted from the timing vector classifier 950 to a main system. If the verification result is negative, then the main system prohibits the user from accessing the main system. However, if the verification result is affirmative, then the main system permits the user to access the main system.

FIG. 10 describes a user authentication system based on keystroke dynamics in accordance with one embodiment of the present invention, wherein the elements of the system are distributed over a communication network. In this embodiment, a client system 1010 may be included in or connected to any type of computing device such as ATM, cellular phone, smart card, laptop computer, desktop computer, workstation, etc., which is connected to the communication network 1020. The client system 1010 includes a timing cue generation module 1012 and a timing vector generation module 1014. The timing cue generation module 1014 generates and presents timing cues to a user. The user then uses the timing cues when typing a password through an input device (not shown). As mentioned above, the timing cues include at least one auditory, visual and/or audiovisual cue. Further, a number of exemplary artificial rhythms may be presented to the user through an output device before or when the timing cue generation module 1012 presents the timing cues to the user. The timing vector generation module 1014 receives keystrokes from a user through the input device and generates a timing vector based on the received keystrokes. The timing vector generated based on the received keystrokes may include information based on a series of alphanumeric characters, durations of the characters and intervals between the characters.

In the user enrollment stage, the timing vector generated by the timing vector generation module 1014 is transmitted to a server system 1030 through a communication network 1020 and then stored in a timing vector database 1032. The server system 1030 may be included in or connected to any type of computing device such as the web server, gateway and switching device distributed over the communication network. The timing vector database 1032 stores a list of users and a plurality of sets of timing vectors corresponding to the users, which are used by a classifier building module 1034 in building a timing vector classifier 1036. As discussed with reference to FIG. 9, if the timing vector classifier 1036 employs a simple pattern matching algorithm such as Euclidean distance metric, then the classifier building module 1034 can be omitted from the user authentication system 1000.

In the user authentication stage, the timing vector classifier 1036 of the server system 1030 receives a timing vector generated by the timing vector generation module 1014 through the communication network 1020. Then, the timing vector classifier 1036 performs a user verification procedure based on the received timing vector and/or the timing vector registered in the user enrollment stage. The user verification result is transmitted from the timing vector classifier 1036 to a main system, which controls the access of the user based on the user verification result.

The user authentication system as shown in FIG. 10 is preferably employed in a networked environment, wherein a user accesses to a remote main system through the wired/wireless network. In this embodiment, although the elements of the user authentication system 1000 have been described to be distributed in two components (i.e., client system 1010 and server system 1030), the elements of the system may be distributed in more than two components over the communication network 1020. The communication network 1020 may be a wireless/wired Internet, campus/enterprise intranet, wide area network (WAN), local area network (LAN) or any other type of network or Internet. It should be noted herein that the present invention can be applied to networks that use any of a variety of communication techniques, including wireless data networks employing CDMA, TDMA, GSM technologies, datagram based networks (e.g., the Internet), connection based networks, virtual circuit based, e.g., Asynchronous Transfer Mode (ATM) networks, etc. Further, the client system 1010 may be any type of computing device having wired/wireless communication capability such as mobile phone, PDA (personal digital assistant), portable email device, laptop computer, desktop computer, etc.

In the embodiments illustrated in FIGS. 9 and 10, only one timing vector classifier is provided to perform a user verification process. Further, a plurality of timing vector classifiers may be prepared for a respective user. In addition, the classifier building module and the timing vector classifier may employ any type of pattern matching or recognition algorithms such as neural network, support vector machine and genetic algorithm.

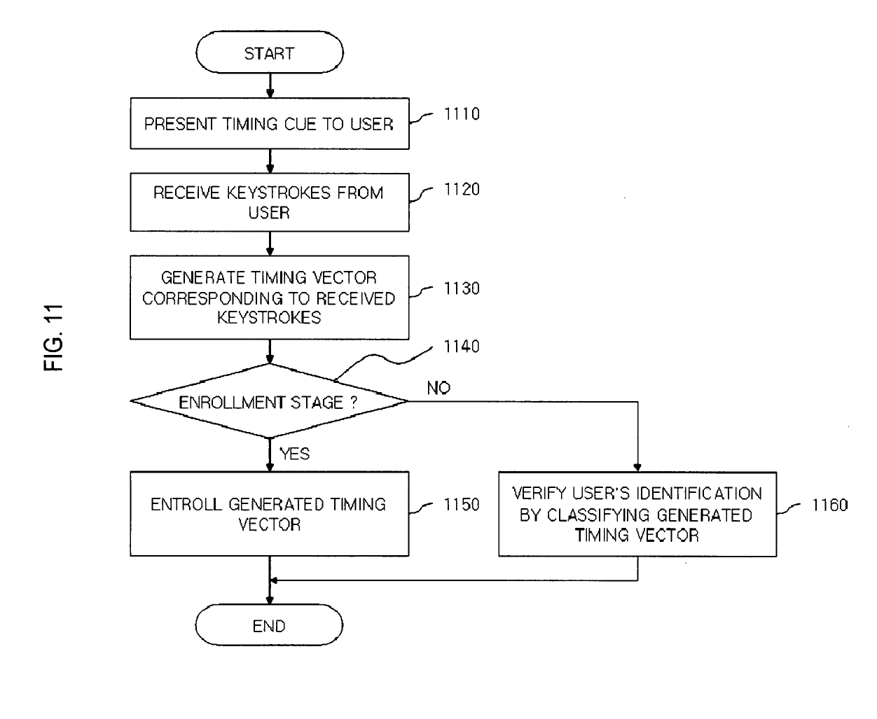

FIG. 11 sets forth a flowchart for a method of performing user authentication based on keystroke dynamics in accordance with one embodiment of the present invention. In this embodiment, the timing cues are generated and presented to a user. The user then uses the timing cues when typing a password to access a main system (operation 1110). As mentioned above, the timing cues include at least one auditory, visual and/or audiovisual cue. Further, although not shown in FIG. 11, a number of exemplary artificial rhythms may be presented to the user before or at the time of presenting the timing cues to the user. As such, the user can select one of the artificial rhythms to be used when typing the password. Then, the keystrokes are received from the user, wherein the timing vector is generated based on the received keystrokes (operations 1120 and 1130). The timing vector generated based on the received keystrokes may include information based upon a series of alphanumeric characters, durations of the characters and intervals between the characters.

Thereafter, when in the user enrollment stage, the generated timing vector is enrolled as a training timing vector for building a timing vector classifier or a template timing vector for the user (operations 1140 and 1150). Generally, it is preferable that a large number of training timing vectors are available for building the timing vector classifier so as to secure practically acceptable error rates. However, since the timing cues are provided to assist the user when typing a password having more consistent patterns, only a small number of training timing vectors is necessary for building a classifier having an acceptable error rate.

On the other hand, when in the user authentication stage, a user verification procedure is performed based on the received timing vector and/or the timing vector registered in the user enrollment stage (operations 1140 and 1160). The classifier may determine if the difference between the received timing vector and the enrolled timing vector falls within a predetermined threshold. If the verification result is negative, then a main system prohibits the user from accessing the main system. However, if the verification result is affirmative, then the main system permits the user to access the main system.

While the present invention and its various functional components have been described in particular embodiments, it should be appreciated that the present invention can be implemented in hardware, software, firmware, middleware or a combination thereof and utilized in systems, subsystems, components or sub-components thereof. When implemented in software, the elements of the present invention are the instructions/code segments for performing the necessary tasks. The program or code segments can be stored in a computer readable medium, such as a processor readable medium or a computer program product. Alternatively, they can be transmitted by a computer data signal embodied in a carrier wave, or a signal modulated by a carrier, over a transmission medium or communication link. The computer-readable medium or processor-readable medium may be any type of medium, which can store or transfer information in a form that is readable and executable by a machine (e.g., processor, computer, etc.).

Further, while the present invention has been shown and described with respect to a preferred embodiment, those skilled in the art will recognize that various changes and modifications may be made without departing from the spirit and scope of the invention as defined in the appended claims.

What is claimed is:

1. A method of generating a timing vector for use in a user authentication system based on keystroke dynamics, comprising the steps of:
presenting timing cues to a user;
receiving keystrokes typed by the user according to the timing cues; and
generating a timing vector based on the received keystrokes.

2. The method of claim 1, wherein the timing cues include at least one auditory cue, visual cue and audiovisual cue.

3. The method of claim 2, wherein the auditory cue includes a repetitive sound played in a certain fixed tempo.

4. The method of claim 2, wherein the visual cue includes a repetitive movement shown in a certain fixed tempo.

5. The method of claim 2, wherein the audiovisual cue includes sound and movement rendered in a certain fixed tempo.

6. The method of claim 1, further comprising the step of:
presenting a list of exemplary artificial rhythms to the user,
wherein the user selects at least one of the artificial rhythms as keystroke dynamics.

7. The method of claim 6, wherein the artificial rhythms include at least one pause, musical rhythm, staccato, legato and slow tempo.

8. A computer-readable medium storing computer-executable instructions for performing the method as described in any one of claims 1 to 7.

9. A user authentication system based on keystroke dynamics, comprising:
a timing cue generation module for generating and presenting timing cues to a user; and
a timing vector generation module for receiving keystrokes typed by the user according to the timing cues and generating a timing vector based on the received keystrokes.

10. The system of claim 9, wherein the timing cues include at least one auditory cue, visual cue and audiovisual cue.

11. The system of claim 10, wherein the auditory cue includes a repetitive sound played in a certain fixed tempo.

12. The system of claim 10, wherein the visual cue includes a repetitive movement shown in a certain fixed tempo.

13. The system of claim 10, wherein the audiovisual cue includes sound and movement rendered in a certain fixed tempo.

14. The system of claim 9, further comprising:
an artificial rhythm generation module for presenting a list of exemplary artificial rhythms to the user,
wherein the user selects at least one of the artificial rhythms as keystroke dynamics.

15. The system of claim 14, wherein the artificial rhythms include at least one pause, musical rhythm, staccato, legato and slow tempo.

16. The system of claim 9, further comprising:
a timing vector database for storing the generated timing vector;
a classifier building module for building a timing vector classifier based on the timing vector stored in the timing vector database; and
a timing vector classifier for performing a user verification based on the generated timing vector.

17. A method of performing a user authentication based on keystroke dynamics, comprising the steps of:
presenting timing cues to a user;
receiving keystrokes typed by the user according to the timing cues;
generating a timing vector based on the received keystrokes;
if in a user enrollment stage, then enrolling the generated timing vector for the user; and
if in a user authentication stage, then performing a user verification process based on the generated timing vector.

18. The method of claim 17, wherein the timing cues include at least one auditory cue, visual cue and audiovisual cue.

19. The method of claim 18, wherein the auditory cue includes a repetitive sound played in a certain fixed tempo.

20. The method of claim 18, wherein the visual cue includes a repetitive movement shown in a certain fixed tempo.

21. The method of claim 18, wherein the audiovisual cue include sound and movement rendered in a certain fixed tempo.

22. The method of claim 17, further comprising the step of:
presenting a list of exemplary artificial rhythms to the user,
wherein the user selects at least one of the artificial rhythms as keystroke dynamics.

23. The method of claim 22, wherein the artificial rhythms include at least one pause, musical rhythm, staccato, legato and slow tempo.

24. A computer-readable medium storing computer-executable instructions for performing the method as described in any one of claims 17 to 23.
